(19) United States
(12) Patent Application Publication
(10) Pub. No.: US 2020/0381778 A1
(43) Pub. Date: Dec. 3, 2020

(54) BATTERIES WITH SOFT MATERIALS BASED ON BORON COMPOUNDS

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US)

(21) Appl. No.: 16/425,096

(22) Filed: May 29, 2019

(51) Int. Cl. H01M 10/0564; C07F 5/02

(52) U.S. Cl. CPC H01M 10/0564; H01M 2300/0065; C07F 5/027

(57) ABSTRACT

Electrochemical cells have soft solid state electrolyte compositions, including a metal salt dispersed or doped in a soft solid matrix. The matrix includes an organic cation and a first boron cluster anion. The metal salt has a metal cation and an anion. The electrolyte compositions are soft, being functionally molded at pressured lower than those required by competing solid electrolytes, and show high ionic conductivity relative to competing electrolyte.

### TECHNICAL FIELD

The present disclosure generally relates to soft solid electrolytes for use in secondary batteries, and to boron cluster chemistry.

### BACKGROUND

Solid-state electrolytes provide many advantages in secondary battery design, including mechanical stability, no volatility, and ease of construction. Existing inorganic solid-state electrolytes displaying high ionic conductivity are usually hard materials that fail to maintain appreciable contact with the electrode materials through battery cycling. Organic solid-state electrolytes, like polymers, overcome the latter issue due to their reduced hardness; however, these suffer from poor ionic conductivity.

Those solid-state electrolytes having appreciable ionic conductivity are generally based on organic ionic liquid crystals (OIPCs). These materials depend on a solid-solid phase transition to achieve high conductivity. OIPC-based materials can suffer from difficulties, including low melting points and/or low temperature windows of the conducting phase that limit their applicability.

Thus, it would be desirable to provide electrochemical cells having improved solid-state electrolytes that rival the conductivity of OIPC-based electrolytes but do not rely on a phase transition with its attendant limitations.

### SUMMARY

This section provides a general summary of the disclosure, and is not a comprehensive disclosure of its full scope or all of its features.

In one aspect, an electrochemical cell having a solid electrolyte composition for use in a secondary battery is disclosed. The electrolyte composition includes a soft solid matrix of the formula GₚA, wherein G is an organic cation from among a list of possible cations, p is 1 or 2; and A is a boron cluster anion. The electrolyte composition further includes a metal salt having a metal cation and an anion. The anion of the metal salt can optionally be a boron cluster anion that is the same as or different from the boron cluster anion, A, of the soft solid matrix. The electrolyte composition is generally in a solid state when at a steady-state operating temperature of the electrochemical cell.

In some implementations, the boron cluster anion is, A, of the soft solid matrix is defined by any of the following anion formulae: [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻ or [C₂B_{(y-t-j-1)}RₜXⱼ]²⁻. In various implementations, y can be an integer within a range of 6 to 12; (z+i) can be an integer within a range of 0 to y; (t+j) can be an integer within a range of 0 to (y−1); and X can be F, Cl, Br, I, or a combination thereof. R can be an organic substituent, hydrogen, or a combination thereof. In various implementations, a boron cluster anion of the metal salt, when present, can be independently defined by any of the above formulae.

In additional aspects, an electrochemical cell having a solid electrolyte composition for use in a secondary battery is disclosed. The electrolyte composition includes a soft solid matrix of the formula GₚA, wherein G is an organic cation from among a list of possible cations, p is 1 or 2; and A is a boron cluster anion as defined above. The electrolyte composition further includes a metal salt having a metal cation and an anion. The anion of the metal salt can optionally be a boron cluster anion that is the same as or different from the boron cluster anion, A, of the soft solid matrix. The electrolyte composition generally has hardness (elastic modulus) less than about 10 gigapascals.

These and other features of the method for forming a soft solid electrolyte and the electrochemical cell having the same will become apparent from the following detailed description when read in conjunction with the figures and examples, which are intended to be illustrative and not exclusive.

### BRIEF DESCRIPTION OF THE DRAWINGS

Various aspects and advantages of the invention will become apparent and more readily appreciated from the following description of the embodiments taken in conjunction with the accompanying drawings, of which:

FIG. 1A is a perspective schematic view of a representative boron cluster anion of the present disclosure, closo-[B₁₂H₁₂]²⁻;

FIG. 1B is a perspective schematic view of a boron cluster anion of the present disclosure, closo-[CH₁₁H₁₂]⁻;

FIG. 1C is a perspective schematic view of a boron cluster anion of the present disclosure, closo-[C₂B₁₀H₁₁]⁻;

FIG. 2A is a plot of Differential Scanning calorimetry (DSC) data for a soft solid matrix (solid matrix) of an electrolyte of the present teachings, N-methyl-N-butyl pyrrolidinium closo-[CB₁₁H₁₂]⁻;

FIG. 2B is a plot of Differential Scanning calorimetry (DSC) data for a solid matrix of the present teachings, triethylhexylphosphonium closo-[CB₁₁H₁₂]⁻ doped with LiCB₁₁H₁₂;

FIG. 3 is a plot of ionic conductivity for multiple solid matrices of the present teachings, each having a closo-[CB₁₁H₁₂]⁻ anion;

FIG. 4 is a plot showing conductivity as a function of temperature for a solid matrix of the present teachings, at two applied pressures;

FIG. 5 is a plot of ionic conductivity in N-methyl-N-butyl pyrrolidinium CB₁₁H₁₂ doped with LiCB₁₁H₁₂, inset with a photographic image of the soft electrolyte; and

FIG. 6 is a plot of ionic conductivity of different soft electrolytes of the present teachings, having a 1:1 molar ratio of LiCB₉H₁₀:LiCB₁₁H₁₂ in N-methyl-N-butyl pyrrolidinium CB₉H₁₀ or N-methyl-N-butyl pyrrolidinium CB₁₁H₁₂.

### DETAILED DESCRIPTION

The present teachings provides electrochemical cells having soft electrolyte compositions similar to organic ionic liquid crystals (OIPCs). The soft electrolyte compositions are typically solid at battery operating temperatures but have unusually high ionic conductivity due to a highly entropic, plastic-like molecular structure.

Electrochemical cells of the present teachings include novel soft electrolyte compositions. The electrolyte compositions have a metal boron cluster salt, and a soft solid matrix (solid matrix) which is doped with the salt. The solid matrix includes a boron cluster anion and an organic cation having flexible and/or asymmetrical substituents. The resulting electrolytes form soft solids having a plastic or glass-like, highly entropic molecular structure that yields high ionic mobility and conductivity.

Thus, a soft solid electrolyte composition (referred to hereinafter simply as, “the electrolyte composition”) for use in secondary batteries is disclosed. The electrolyte composition includes a solid matrix having a formula GₚA, where G is an organic cation, A is a boron cluster anion, and p is either one or two. In some implementations, the organic cation can include at least one of an ammonium and a phosphonium cation, such as the examples shown below as Structures 1-4.

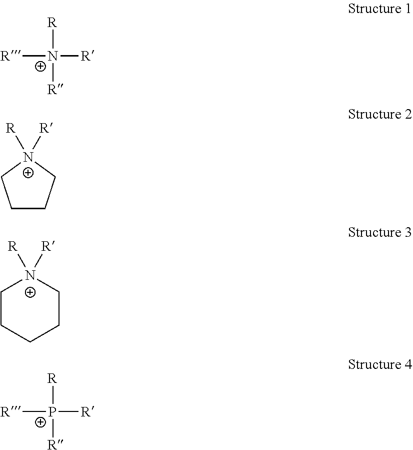

where R and, where present, R′, R″ and R′″ is each, independently a substituent belonging to any of: group (i) a linear, branched-chain, or cyclic C1-C8 alkyl or fluoroalkyl group; group (ii) a C6-C9 aryl or fluoroaryl group; group (iii) a linear, branched-chain, or cyclic C1-C8 alkoxy or fluoroalkoxy group; group (iv) a C6-C9 aryloxy or fluoroaryloxy group, group (v) amino; and group (vi) a substituent that includes two or more moieties as defined by any two or more of groups (i)-(v). The substituents R, R′, and where present R″ and R′″ can be alternatively referred to hereinafter as a “plurality of organic substituents. In general, the organic cation will have some degree of asymmetry with respect to the size and distribution of substituents. Thus, at least one of R, R′, R” and R′″ will be different from the others, and the cation will preferably not include two pairs of substituents.

In certain particular implementations, the organic cation can be selected from the group including: N-methyl-N-propylpyrrolidinium (referred to hereinafter as “Pyr13”); N-methyl-N,N-diethyl-N-propylammonium (N1223); N,N-diethyl-N-methyl-N-(2-methoxyethyl)-ammonium (DEME); N-methyl-N-propylpiperidinium (referred to hereinafter as “Pip13”); N-methyl-N-(2-methoxyethyl)-pyrrolidinium (Pyr1201); trimethylisopropylphosphonium (P111,4); methyltriethylphosphonium (P1222); methyltributylphosphonium (P1444); N-methyl-N-ethylpyrrolidinium (Pyr12); N-methyl-N-butylpyrrolidinium (Pyr14); N,N,N-triethyl-N-hexyl ammonium (N2226); triethylhexylphosphonium (P2226); and N-ethyl-N,N-dimethyl-N-butylammonium (N4211). It is to be understood that, in some implementations, G can include more than one of the aforementioned cations. It is to be understood that when p equals two, the two organic cations contained in the stoichiometric unit of the solid matrix can be the same cation or can be two different cations.

As used herein, the phrase “boron cluster anion” generally refers to an anionic form of any of the following: a borane having 6-12 boron atoms with a net −2 charge; a carborane having 1 carbon atom and 5-11 boron atoms in the cluster structure with a net −1 charge; a carborane having 2 carbon atoms and 4-10 boron atoms in the cluster structure with a net −1 or −2 charge. In some variations, a boron cluster anion can be unsubstituted, having only hydrogen atoms in addition to the aforementioned. In some variations, a boron cluster anion can be substituted, having: one or more halogens replacing one or more hydrogen atoms; one or more organic substituents replacing one or more hydrogen atoms; or a combination thereof.

In some implementations, the boron cluster anion can be an anion having any formula of:

[B_{y}H_{(y-z-i)}R_{z}Xᵢ]²⁻ Anion Formula I,

[CB_{(y—1)}H_{(y-z-i)}R_{z}Xᵢ]⁻ Anion Formula II,

[C₂B_{(y-2)}H_{(y-t-j-1)}RₜXⱼ]⁻ Anion Formula III,

[C₂B_{(y-3)}H_{(y-t-j)}RₜXⱼ]⁻ Anion Formula IV, or

[C₂B_{(y-3)}H_{(y-t-j-1)}RₜXⱼ]²⁻ Anion Formula V,

wherein y is an integer within a range of 6 to 12; (z+i) is an integer within a range of 0 to y; (t+j) is an integer within a range of 0 to (y−1); and X is F, Cl, Br, I, or a combination thereof. Substituent R as included in Anion Formulae I-V can be any organic substituent or hydrogen.

It is to be understood that X can be F, Cl, Br, I, or a combination thereof, this indicates that when i is an integer within a range of 2 to y, or j is an integer within a range of 2 to (y−1), this indicates that a plurality of halogen substituents is present. In such a situation, the plurality of halogen substituents can include F, Cl, Br, I, or any combination thereof. For example, a boron cluster anion having three halogen substituents (i.e. where i or j equals 3), the three halogen substituents could be three fluorine substituents; 1 chlorine substituent, 1 bromine substituent, and 1 iodine substituent; or any other combination.

In many implementations, the boron cluster anion can include any of a substituted or unsubstituted closo-boron cluster anion. In some implementations, the boron cluster anion will be a closo-boron cluster anion, such as closo-[B₆H₆]²⁻, closo-[B₁₂H₁₂]²⁻, closo-[CB₁₁H₁₂]⁻, or closo-[C₂B₁₀H₁₁]⁻.

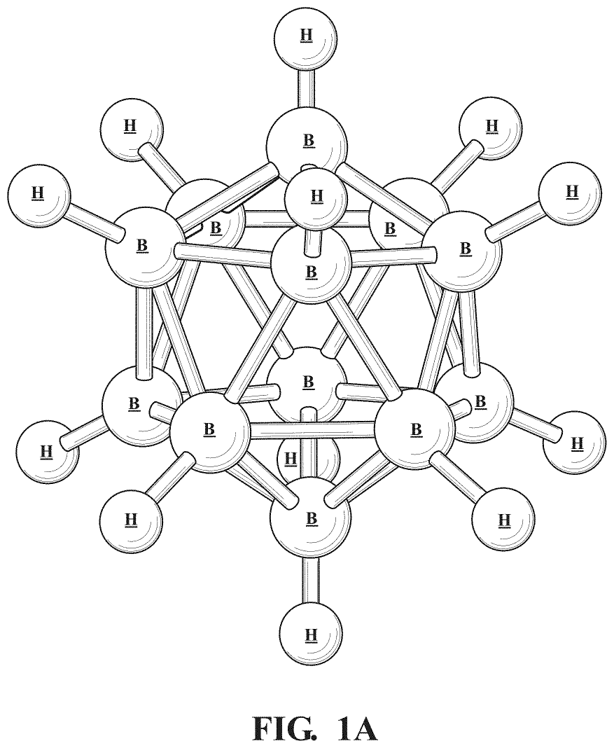

FIGS. 1A-1C show structures of exemplary unsubstituted boron cluster anions according to Anion Formulae I-V, respectively. Specifically, FIGS. 1A-1C show closo-[B₁₂H₁₂]²⁻, closo-[CB₁₁H₁₂]⁻, closo-[C₂B₁₀H₁₁]⁻, respectively. The exemplary doso-[C₂B₁₀H₁₁]⁻ anion of Anion Formula III is shown as a 1,2-dicarba species, however it will be appreciated that such a closo-icosahedral dicarba species can alternatively be 1,7- or 1,12-dicarba. More generally, it is to be understood that the required carbon atoms of Anion Formulae III, IV, and V can occupy any possible positions in the boron cluster skeleton. It is also to be understood that non-hydrogen substituents, when present on a boron cluster anion, can be attached at any position in the boron cluster skeleton, including at vertices occupied by either boron or carbon, where applicable.

In some implementations, the electrolyte composition exhibits no phase transition below 80° C. and at standard pressure, as determined by DSC.

The electrolyte composition also includes a metal salt having a metal cation and anion. The anion associated with and/or derived from the metal salt can be referred to hereinafter as “the metal salt anion.” The metal salt will generally be selected on the basis of the electrochemistry of the battery in which the electrolyte composition will be used. In different variations, the metal cation can be Li⁺, Na⁺, Mg²⁺, Ca²⁺, or any other electrochemically suitable cation.

In some implementations, the metal salt anion can be any boron cluster anion of the types described above. In some such implementations of the electrolyte, the boron cluster anion of the metal salt can be the same as the boron cluster anion of the soft solid electrolyte, and in some implementations, the two boron cluster anions can be different. In other variations, the metal salt anion can be any anion suitable for use in battery chemistry, such as TFSI, BF₄, PF₆, or FSI.

The solid matrix will generally be doped with the metal salt to form the electrolyte composition. Doping can be performed by attaining intimate contact between matrix salt and doping salt. One method to achieve this is to dissolve the dopant salt in the molten organic salt matrix (melt infusion). Another method is by dissolving all components in a solvent, mixing and removing the solvent to yield a solid material. Note that conditioning of the material using hand milling or ball milling prior or after melt infusion can be applied.

In some implementations, the electrolyte composition will include metal salt present at a molar ratio, relative to solid matrix, within a range of about 1:100 to about 100:1. More preferably, in some implementations, the electrolyte composition will include metal salt present at a molar ratio, relative to solid matrix, within a range of about 5:100 to about 1:1.

In some implementations, the electrolyte composition exhibits ionic conductivity greater than 10⁻¹⁰ S/cm in the solid state. It will additionally be noted that soft solid electrolytes of the present teachings are substantially softer than most current state-of-the-art solid electrolytes. For example, the elastic modulus of a typical sulfide solid state electrolyte is approximately 26 gigapascals (GPa). In contrast, a soft solid electrolyte having a solid matrix of Pyr14:CB₉H10 with 80% metal salt consisting of a 1:1 molar ratio of LiCB₉H₁₀:LiCB₁₁H₁₂ has elastic modulus (a measure of hardness) of only 0.214 GPa. Similarly, a soft solid electrolyte having a solid matrix of Pyr14:CB₁₁H₁₂ with 45% LiCB₁₁H₁₂ metal salt has elastic modulus of only 2.36 GPa. Thus, in some implementations, a soft solid electrolyte of the present teachings can have elastic modulus less than about 10 GPa, or less than about 1 GPa, or less than about 0.5 GPa.

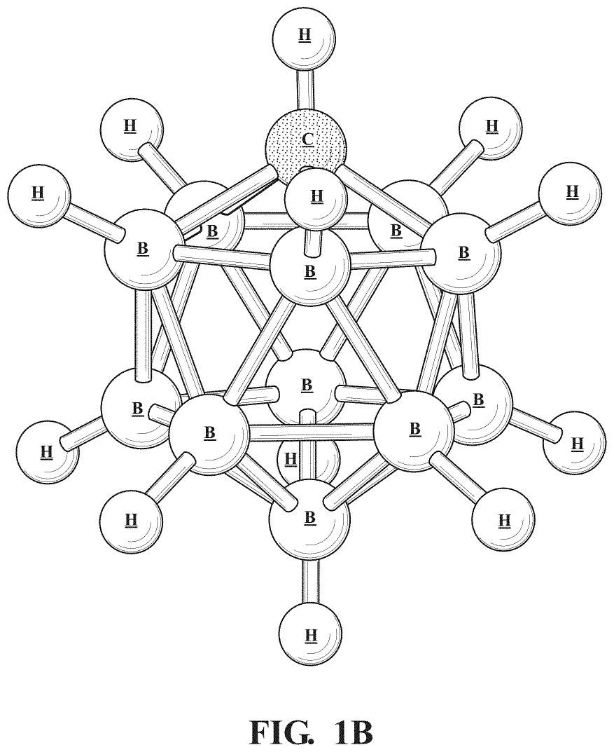

FIGS. 2A and 2B shows a plot of Differential Scanning calorimetry (DSC) data for a soft solid matrix (solid matrix) of the present teachings: Pyr14: CB₁₁H₁₂ and P2226: CB₁₁H₁₂. It is to be noted that no phase transitions are found below 100° C. and 95° C., respectively.

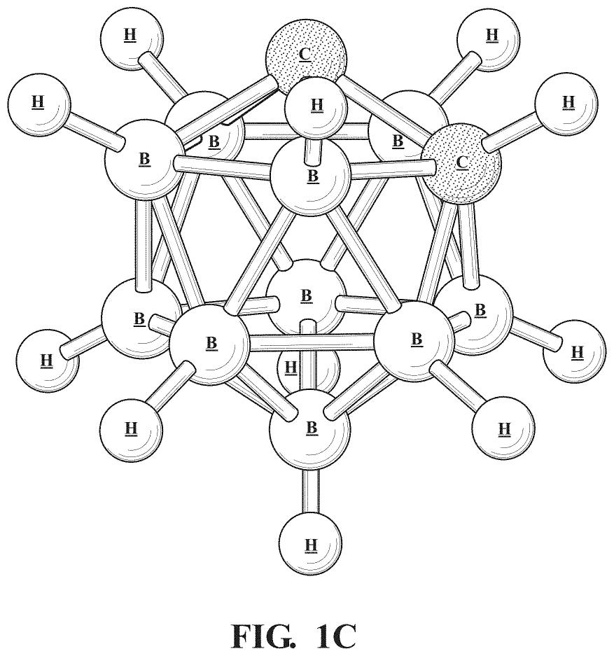

FIG. 3 is a plot of ionic conductivity for neat solid matrix of the present teachings having a closo-[CB₁₁H₁₂]⁻ anion. The results of FIG. 3, along with those of FIGS. 2A and 2B, establish that the materials have appreciable ionic conductivities below 95° C., despite not having any phase transition below that temperature.

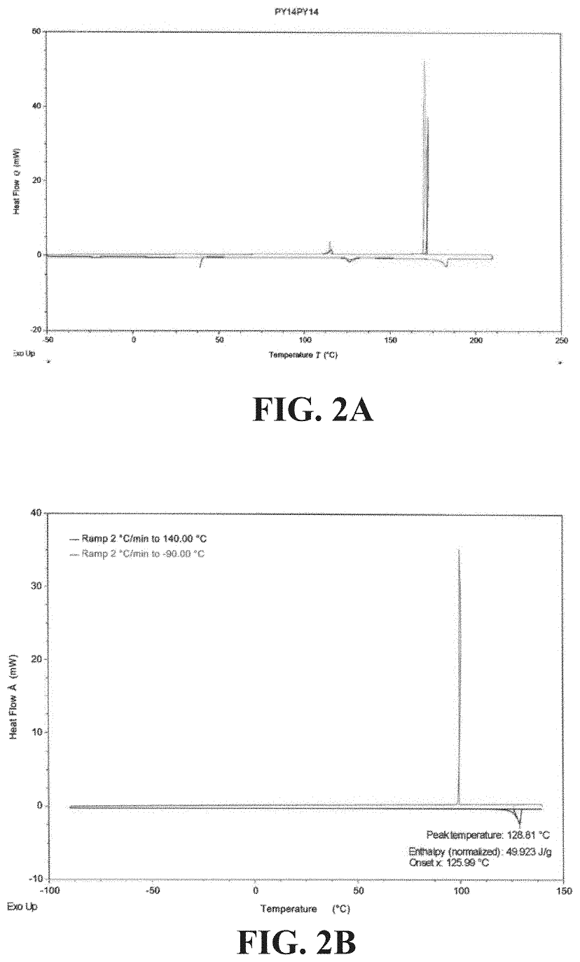

FIG. 4 is a plot showing conductivity at varying temperatures, and at two applied pressures for N2224:CB₁₁H₁₂ doped with LiCB₁₁H₁₂. It is to be noted that the disclosed electrolyte compositions are soft solids, and that their “softness” is quantified based on the amount of pressure needed to obtain maximum ionic conductivity (i.e. harder materials would generally require greater applied pressure to achieve maximum conductivity). To this point, it will be understood that solid-state electrolytes are typically formed into their desired shape by compacting granules or powder of the solid electrolyte, such as in a dye press. Harder materials will require greater pressure to achieve adequate compaction and grain contact, whereas softer materials will be adequately compacted at lower pressure.

The results of FIG. 4 show that the cell having an electrolyte pressed at 1 ton pressure shows stable data within 2 cycles at all temperatures. At 3 tons applied pressure, the conductivity at the second cycle is slightly smaller than that in the first cycle. These results show that low pressures of 1 ton are sufficient to achieve excellent grain to grain contact to obtain the optimum conductivity, and demonstrate the softness of the disclosed electrolyte compositions. For comparison, 1 ton pressure is about ¼ what is needed to form good contacts for state of the art Li sulfide solid state electrolytes.

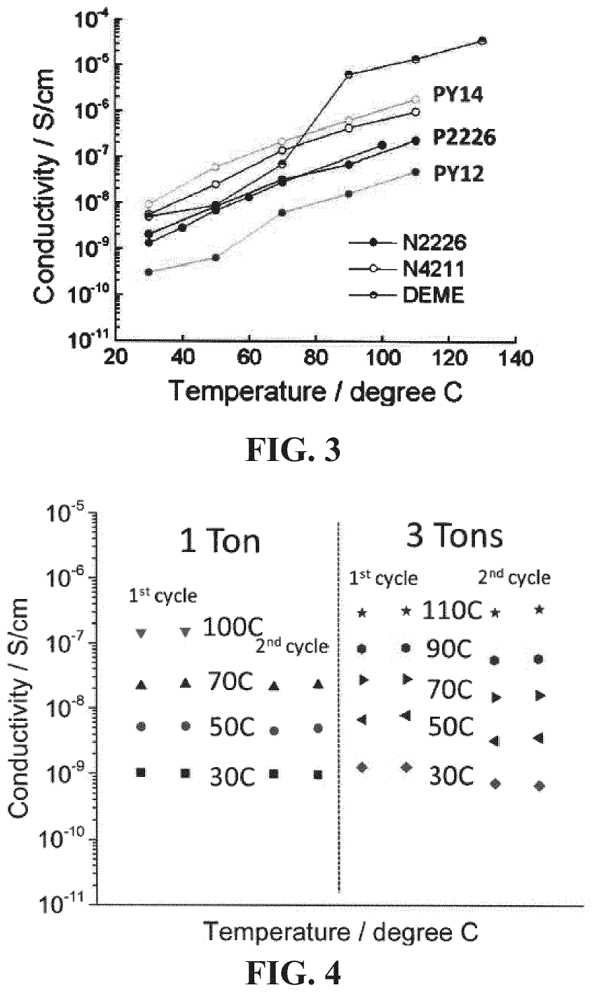

FIG. 5 is a plot of ionic conductivity in Pyr14:CB₁₁H₁₂ doped with LiCB₁₁H₁₂, inset with a photographic image of the soft electrolyte. The electrolyte composition of FIG. 5 is prepared by mixing the components at 125° C. for 15 minutes, followed by cooling to room temperature to yield a solid material. The solid material is then hand milled in a mortar and pestle. The solid powder obtained by this procedure is converted into a round pellet (shown in the inset of FIG. 5) by applying 3 tons of pressure in a dye press. The results demonstrate that very high ionic conductivity can be obtained with the electrolyte compositions of the present teachings, without any need for a phase transition. Absence of grain boundaries, as apparent from sample transparency, in addition to high Li conductivity are shown. Very high Li-ion transference number of 0.86 has also been measured for this material (data not shown) which far exceeds that of all known soft materials such as polymers and all other OIPC type materials (less than 0.5).

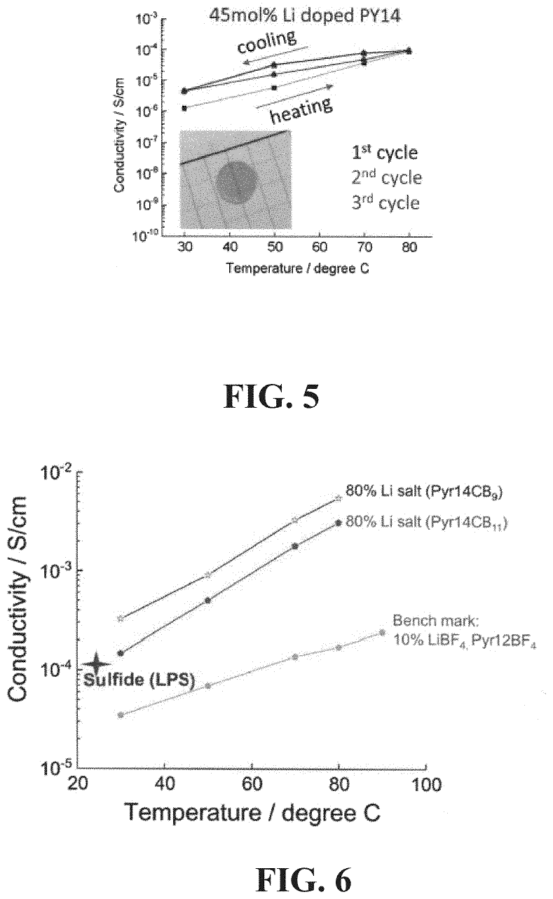

FIG. 6 is a plot of ionic conductivity of different soft electrolytes of the present teachings, having a 1:1 molar ratio of LiCB₉H₁₀:LiCB₁₁H₁₂ as Li salt in Pyr14:CB₉H₁₀ or Pyr14:CB₁₁H₁₂. The compositions of FIG. 6 are prepared by mixing the components using hand milling followed by mixing for 24 hours in a molten state, followed by cooling to room temperature, yielding a solid material. The solid material is hand milled in a mortar and pestle to produce a solid powder. The electrolyte is formed by applying 3 tons pressure in a dye press. It will be noted that the conductivity of the resulting materials is high, compared to a state-of-the-art solid-state electrolyte, lithium phosphorous sulfide (LPS). It will further be noted that LPS grains require pressure of at least 4 tons to achieve useful conductivity, further demonstrating the softness of the electrolyte compositions of the present teachings.

Additionally, provided herein is an electrochemical cell comprising an electrolyte composition as described above. The electrochemical cell will generally be a secondary battery wherein a reduction/oxidation reaction occurs with an active material such as lithium, sodium, calcium, magnesium, a dual-ion system, or any other suitable electrochemical system for a secondary battery.

The electrochemical cell of the present teachings can generally have an anode, a cathode, and an electrolyte placing the anode and cathode in ionic communication with one another. The electrolyte can be a solid electrolyte composition as described above. It is to be understood that the term “anode” as used herein refers to an electrode at which magnesium oxidation occurs during cell discharge and at which magnesium reduction occurs during cell charging. Similarly, it is to be understood that the term “cathode” refers in such implementations to an electrode at which a cathode material reduction occurs during cell discharge and at which a cathode material oxidation occurs during cell charging.

It will be understood that the electrochemical cell of the present teachings generates heat during operation, and will generally have a steady-state operating temperature, or temperature range (referred to herein as “the battery operating temperature”). This describes the temperature of the electrochemical cell, and particularly of the electrolyte, when the battery has operated under normal operating conditions for a sufficient time to reach the steady-state temperature. The electrochemical cell can also have a maximum operating temperature, a maximum temperature (particularly electrolyte temperature) at which the electrochemical cell is designed to operate. In many implementations, the soft solid electrolyte of the electrochemical cell will have sufficiently high melting point that it remains solid at the battery operating temperature, including at the maximum operating temperature. This is in contrast to many state of the art electrolytes which may be solid at room temperature, but which are designed to be molten at the battery operating temperature because they achieve suitable conductivity only in the molten state. It will be understood that the considerably high solid-state ionic conductivity of the soft solid electrolytes of the present teachings, as described above, enables the electrochemical cell to operate with the electrolyte continuously in the solid state.

The electrochemical cell can further have at least one external conductor, the external conductor being configured to enable electrical communication between the anode and the cathode.

The anode can comprise any material or combination of materials effective to participate in electrochemical oxidation of the active material (e.g. lithium) during a cell discharge. This can alternatively be described by saying that the anode is configured to incorporate and/or release the active material. Similarly, the anode can comprise any material or combination of materials effective to participate in electrochemical reduction of active cations and to incorporate reduced active material during a cell charging event. In some implementations, the anode can consist essentially of elemental active material (e.g. lithium metal) or comprise at least one surface layer of elemental active material. In other implementations, the anode can comprise an alloy-type such as a tin or silicon, bismuth type anode, insertion type material, containing active material in complex or alloy with other materials to the extent the cell is charged.

The cathode can comprise any material or combination of materials effective to participate in electrochemical insertion of metal cations during a cell discharge. Similarly, the cathode can comprise any material or combination of materials effective to participate in electrochemical extraction of active material during a cell charging event. Suitable but non-exclusive examples of such materials can include LiCoO₂, low cobalt oxide cathodes, FeSiO₄, LiFePO₄, Li rich cathodes, spinel oxide cathodes, conversion cathodes like sulfur, organosulfur compounds, air, oxygen, or any other suitable materials.

In a simple implementation, the external conductor can be a single conductor such as wire connected at one end to the anode and at an opposite end to the cathode. In other implementations, the external conductor can include a plurality of conductors putting the anode and the cathode in electrical communication with a device configured to supply power to the electrochemical cell during a charging event, with other electrical devices situated to receive power from the electrochemical cell, or both.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An electrochemical cell comprising:
an anode;
a cathode; and
an electrolyte composition placing the anode and cathode in ionic communication with one another, the electrolyte composition comprising:
a soft solid matrix (solid matrix) of the formula GₚA, wherein:
G is an organic cation selected from the group consisting of:
ammonium and phosphonium, having a plurality of organic substituents, each organic substituent of the plurality of organic substituents independently selected from the group consisting of:
(i) a linear, branched, or cyclic C1-C8 alkyl or fluoroalkyl group;
(ii) a C6-C9 aryl or fluoroaryl group;
(iii) a linear, branched-chain, or cyclic C1-C8 alkoxy or fluoroalkoxy group;
(iv) a C6-C9 aryloxy or fluoroaryloxy group;
(v) amino; and
(vi) a substituent that combines two or more of (i)-(v);
p is 1 or 2; and
A is a boron cluster anion; and
a metal salt having a metal cation and a metal salt anion,
wherein the electrolyte composition is in a solid state when at a steady-state operating temperature of the electrochemical cell.

2. The electrochemical cell as recited in claim 1, wherein the boron cluster anion, A, has a formula of one of [B_{y}H_{(y-z-i)}R_{z}Xᵢ]²⁻, [CB_{(y-1)}H_{(y-z-i)}R_{z}RₜXⱼ]⁻, [C₂B_{(y-2)}H_{(y-t-j-1)}RₜXⱼ]⁻, [C₂B_{(y-3)}H_{(y-t-j)}RₜXⱼ]⁻, and [C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y-1);
X is F, Cl, Br, I, or a combination thereof; and
R comprises any of a linear, branched-chain, or cyclic Cl-C18 alkyl or fluoroalkyl group; an alkoxy or fluoroalkoxy; and a combination thereof.

3. The electrochemical cell as recited in claim 2, wherein the boron cluster anion, A, comprises a closo-boron cluster anion.

4. The electrochemical cell as recited in claim 2, wherein the boron cluster anion, A, comprises at least one of closo-[B₆H₆]²⁻, closo-[B₁₂H₁₂]²⁻, closo-[CB₁₁H₁₂]⁻, and closo-[C₂B₁₀H₁₁]⁻.

5. The electrochemical cell as recited in claim 1, wherein the metal salt anion comprises a boron cluster anion, independent of the boron cluster anion, A, and having a formula of one of [B_{y}H_{(y-z-i)}R_{z}Xᵢ]²⁻, [CB_{(y—1)}H_{(y-z-i)}R_{z}RₜXᵢ]⁻, [C₂B_{(y-2)}H_{(y-t-j-1)}RₜXⱼ]⁻, [C₂B_{(y-3)}H_{(y-t-j)}RₜXⱼ]⁻, [C₂B_{(y-3)}H_{(y-t-j-1)}RₜXⱼ]⁻, and [C₂B_{(y-3)}H_{(y-t-j)}RₜXⱼ]⁻, and wherein:
y is an integer within a range of 6 to 12;
(z+i) is an integer within a range of 0 to y;
(t+j) is an integer within a range of 0 to (y-1);
X is F, Cl, Br, I, or a combination thereof; and
R comprises any of a linear, branched-chain, or cyclic C1-C18 alkyl or fluoroalkyl group; an alkoxy or fluoroalkoxy; and a combination thereof.

6. The electrochemical cell as recited in claim 5, wherein the metal salt anion is a closo-boron cluster anion.

7. The electrochemical cell as recited in claim 5, wherein the boron cluster anion, A, of the soft solid matrix, and the boron cluster anion of the metal salt comprise different anions.

8. The electrochemical cell as recited in claim 5, wherein the boron cluster anion, A, of the soft solid matrix, and the boron cluster anion of the metal salt comprise the same anion.

9. The electrochemical cell as recited in claim 5, wherein the metal salt anion comprises at least one of closo-[B₆H₆]²⁻, closo-[B₁₂H₁₂]²⁻, closo-[CB₁₁H₁₂]⁻, or closo-[C₂B₁₀H₁₁]⁻.

10. The electrochemical cell as recited in claim 1, wherein the metal salt anion comprises at least one of (fluorosulfonyl)imide (FSI); bis(trifluoromethanesulfonyl)imide (TFSI); PF6; and BF₄ anion.

11. An electrochemical cell comprising:
an anode;
a cathode; and
an electrolyte composition placing the anode and cathode in ionic communication with one another, the electrolyte composition comprising:
a soft solid matrix (solid matrix) of the formula GₚA, wherein:
G is an organic cation selected from the group consisting of:
ammonium and phosphonium, having a plurality of organic substituents, each organic substituent of the
plurality of organic substituents independently selected from the group consisting of:
(i) a linear, branched, or cylic C1-C8 alkyl or fluoroalkyl group;
(ii) a C6-C9 aryl or fluoroaryl group;
(iii) a linear, branched-chain, or cyclic C1-C8 alkoxy or fluoroalkoxy group;
(iv) a C6-C9 aryloxy or fluoroaryloxy group;
(v) amino; and
(vi) a substituent that combines two or more of (i)-(v);
p is 1 or 2; and
A is a boron cluster anion; and
a metal salt having a metal cation and a metal salt anion,
wherein the electrolyte composition has elastic modulus of less than about 10 gigapascals (GPa).

12. The electrochemical cell as recited in claim 11, wherein the electrolyte composition has elastic modulus of less than about 1 GPa.

13. The electrochemical cell as recited in claim 11, wherein the electrolyte composition has elastic modulus of less than about 0.5 GPa.

14. The electrochemical cell as recited in claim 11, wherein the metal cation is selected from the group consisting of Li⁺, Na⁺, Mg²⁺, Ca²⁺.

15. The electrochemical cell as recited in claim 11, wherein the metal salt comprises Li(CB₁₁H₁₂).

16. The electrochemical cell as recited in claim 11, wherein G comprises an ammonium cation.

17. The electrochemical cell as recited in claim 11, wherein G comprises a phosphonium cation.

18. The electrochemical cell as recited in claim 11, wherein G comprises a pyrrolidinium or piperidinium cation.

19. The electrochemical cell as recited in claim 11, wherein G comprises a DEME cation.

20. The electrochemical cell as recited in claim 11, wherein the metal salt is present at a molar ratio, relative to the solid matrix, within a range of from about 1:100 to 100:1, inclusive.
